(19) United States
(12) Patent Application Publication
(10) Pub. No.: US 2011/0091847 A1
(43) Pub. Date: Apr. 21, 2011

(54) METHOD, SYSTEM, AND COMPUTER SOFTWARE CODE FOR THE ADAPTATION OF TRAINING VIA PERFORMANCE DIAGNOSIS BASED ON (NEURO)PHYSIOLOGICAL METRICS

(76) Inventors: Meredith Bell Carroll, Melbourne, FL (US); Laura Milham, Orlando, FL (US); Sven Fuchs, Hamburg (DE); David Jones, Casselberry, FL (US); Kelly Hale, Oviedo, FL (US); Malachi Lawson, Oviedo, FL (US)

(21) Appl. No.: 12/905,973

(22) Filed: Oct. 15, 2010

Related U.S. Application Data
(60) Provisional application No. 61/251,960, filed on Oct. 15, 2009.

(51) Int. Cl. G09B 19/00

(52) U.S. Cl. 434/236

(57) ABSTRACT

A method for adapting a training system based on information obtained from a user using a training system during a training scenario, the method including measuring a neurophysiological state, a physiological state, and/or a behavioral state of a user while a training scenario is in progress, diagnosing at least one performance deficiency of the user and/or a learned training objective while the training scenario is in progress, and adapting the training scenario during the training scenario and/or for a subsequent operation of the training scenario in response to information learned during diagnosing the at least one performance deficiency and/or a learned training objective to meet an objective of the training scenario. A system and computer software code for adapting the training system based on information obtained from the user using the training system during a training scenario is also disclosed.

### CROSS-REFERENCE TO RELATED APPLICATIONS

This application claims the benefit of U.S. Provisional Application No. 61/251,960 filed Oct. 15, 2009, and incorporated herein by reference in its entirety.

### STATEMENT OF GOVERNMENT RIGHTS

Exemplary embodiments of the present invention were designed and defined under AF06-T027; Development of the Multi-axis Approach to Measuring and Interpreting Team Communications (MAP IT-C), BAA 07-005 from the Office of Naval Research, and under SBIR Contract N00014-09-M-0140 from the Office of Naval Research. Accordingly, the United States government may have certain rights in the claimed invention.

### BACKGROUND OF THE INVENTION

Assessment of performance is a critical foundation for a learning system. Systems that simply provide opportunities to practice in operational situations lack the capability to monitor, assess, and facilitate learning when a trainee does not perform optimally. Performance assessment supports the overall learning process via the monitoring of a learner's (users' or trainee's) progress on learning objectives targeted in the training system/scenario. This data is valuable, as it can be used to identify when objectives are not met adequately, or when a learner can move to more advanced objectives. In addition, performance assessment data can be used to provide feedback to learners, to point out breakdowns in performance, and to facilitate remediation on failed objectives.

Recent theories on feedback suggests that individualizing or tailoring feedback based on specific errors a trainee has committed can provide trainees with an optimal amount of information needed to improve performance. In some cases, errors are easy to spot during training, as they manifest in easily detectable violations of performance thresholds (e.g., time or accuracy) in performing a task. However, what is detected is the error's observable indicator. The actual error may have been committed (or omitted) much earlier in the process, such as at the information processing stage, where information is gathered from the environment, interpreted, and decisions are made about whether or how to act. Furthermore, many cognitive processing errors do not result in observable activity. In these cases, performance assessment is particularly challenging or often completely impossible with traditional observation-based methods.

In order to provide optimal performance assessment and training feedback, it is critical to be able to identify cognitive Root Cause of errors, that is, the initiating breakdown in a chain of subprocesses or subtasks that cascades into an observable error in performance, so that interventions can address the actual source of the problem as opposed to its observable manifestation. In the case of real-time adaptive training systems, it may even be desirable to intervene before incorrect cognitive processing results in behavioral errors.

Diagnosing information processing errors and cognitive Root Causes is difficult because it is challenging to assess what is happening early in the trainee's information processing. There is currently no real-time capability to measure performance on these tasks using an integrated suite of physiological and behavioral measures, diagnose breakdowns in cognitive information processing, and adapt the training system to provide trainees with individualized feedback tailored to their cognitive processing.

Currently, there are tools that measure early information processing in learners with physiological and neurophysiological information, but the data output is not processed to support diagnosis of cognitive processing errors, root cause analysis, or identification of early intervention opportunities for adaptation in near real-time.

Towards end, developers of training systems/scenarios, instructors, and trainees would benefit from having a near real-time diagnosis of cognitive processing errors and root cause analysis of errors to enable adaptation of training and tailoring of feedback to a trainee's individual information processing either during a training session or available and tailored to the trainee during a subsequent training session.

### BRIEF DESCRIPTION OF THE INVENTION

Embodiments of the present invention relate to a method, system, and computer software code for providing for an adaptable training system which is adaptable based on information obtained from a user using the training system during a training scenario/session. The method comprises measuring a neurophysiological state, a physiological state, and/or a behavioral state of a user while a training scenario is in progress. The method also comprises diagnosing at least one performance deficiency of the user and/or a learned training objective while the training scenario is in progress. The method also comprises adapting the training scenario during the training scenario and/or for a subsequent operation of the training scenario in response to information learned during diagnosing the at least one performance deficiency and/or a learned training objective to meet an objective of the training scenario.

The system comprises a measuring device configured to measure a neurophysiological state, physiological state, and/or a behavioral state of a user while a training scenario is in progress. The system also comprises a diagnostic device configured to identify at least one performance deficiency of the user and/or a learned training objective gathered from the neurophysiological state, physiological state, and/or behavioral state measured while the training scenario is in progress. The system further comprises an adaptation device configured to modify the training scenario during the training scenario and/or for a subsequent running of the training scenario in response to information identified with the diagnostic device to overcome the at least one performance deficiency and/or minimize further training of a learned training objective.

The computer software code is stored on a computer readable media and executable with a processor. The computer software code comprises a computer software module for measuring a neurophysiological state, a physiological state, and/or a behavioral state of a user while a training scenario is in progress, when executed with a processor. The computer software code further comprises a computer software module for diagnosing at least one performance deficiency of the user and/or a learned training objective while the training scenario is in progress, when executed with the processor. The computer software code also comprises a computer software module for adapting the training scenario during the training scenario and/or for a subsequent running of the training scenario in response to information learned during diagnosing the at least one performance deficiency and/or a learned training objective to meet an objective of the training scenario, when executed with the processor.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 discloses a block diagram illustrating an exemplary embodiment of a system for adapting a training system based on information obtained from a user using the training system during a training scenario;

FIG. 2 discloses a block diagram illustrating an exemplary embodiment of a method for adapting a training system based on information obtained from a user using a training system during a training scenario/session;

FIG. 3. discloses an exemplary embodiment of an adaptation of training via performance and diagnosis based on physiological and/or neurophysiological metrics; and

FIG. 4 presents the classification of emotions applicable to a variety of military training exercises.

### DETAILED DESCRIPTION

Reference will be made below in detail to exemplary embodiments of the invention, examples of which are illustrated in the accompanying drawings. Wherever possible, the same reference numerals used throughout the drawings refer to the same or like parts.

Exemplary embodiments of the invention solve problems in the art by providing a method, system, and computer implemented method, such as a computer software code or computer readable media, for providing an adaptable training system which is adaptable based on information obtained from a user using the training system during a training scenario/session.

Persons skilled in the art will recognize that an apparatus, such as a data processing system, including a CPU, memory, I/O, program storage, a connecting bus, and other appropriate components, could be programmed or otherwise designed to facilitate the practice of the method of the invention. Such a system would include appropriate program means for executing the method of the invention.

Also, an article of manufacture, such as a pre-recorded disk, computer readable media, or other similar computer program product, for use with a data processing system, could include a storage medium and program means recorded thereon for directing the data processing system to facilitate the practice of the method of the invention. Such apparatus and articles of manufacture also fall within the spirit and scope of the invention.

Broadly speaking, a technical effect is to provide an adaptable training system which is adaptable based on information obtained from a user using the training system during a training scenario/session. To facilitate an understanding of the exemplary embodiments of the invention, it is described hereinafter with reference to specific implementations thereof. Exemplary embodiments of the invention may be described in the general context of computer-executable instructions, such as program modules, being executed by any device, such as but not limited to a computer, designed to accept data, perform prescribed mathematical and/or logical operations usually at high speed, where results of such operations may or may not be displayed. Generally, program modules include routines, programs, objects, components, data structures, etc. that performs particular tasks or implement particular abstract data types. For example, the software programs that underlie exemplary embodiments of the invention can be coded in different programming languages, for use with different devices, or platforms. It will be appreciated, however, that the principles that underlie exemplary embodiments of the invention can be implemented with other types of computer software technologies as well.

Moreover, those skilled in the art will appreciate that exemplary embodiments of the invention may be practiced with other computer system configurations, multiprocessor systems, microprocessor-based or programmable consumer electronics, minicomputers, mainframe computers, and the like. Exemplary embodiments of the invention may also be practiced in distributed computing environments where tasks are performed by remote processing devices that are linked through at least one communications network. In a distributed computing environment, program modules may be located in both local and remote computer storage media including memory storage devices.

Referring now to the drawings, embodiments of the present invention will be described. Exemplary embodiments of the invention can be implemented in numerous ways, including as a system (including a computer processing system), a method (including a computerized method), an apparatus, a computer readable medium, a computer program product, a computer software code, or a data structure tangibly fixed in a computer readable memory. Several embodiments of the invention are discussed below.

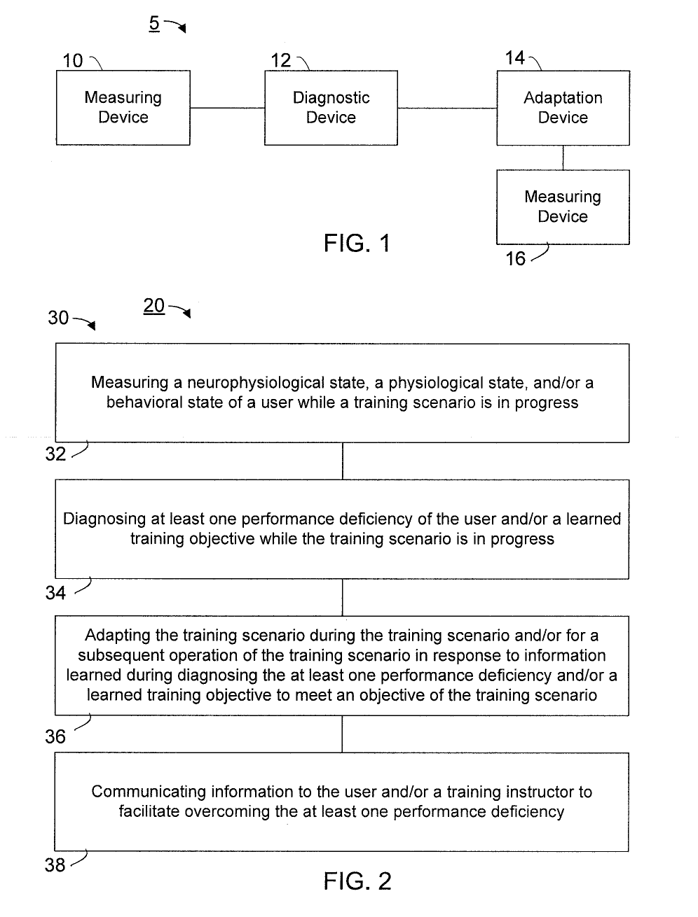

FIG. 1 discloses a block diagram illustrating an exemplary embodiment of a system for adapting a training system based on information obtained from a user using the training system during a training scenario. The system comprises a measuring device 10 configured to measure a neurophysiological state, a physiological state, and/or a behavioral state of a user while a training scenario is in progress. The system further comprises a diagnostic device 12 configured to identify at least one performance deficiency of the user and/or a learned training objective gathered from the neurophysiological state, physiological state, and/or behavioral state measured while the training scenario is in progress, and an adaptation device 14 configured to modify the training scenario during the training scenario and/or for a subsequent running of the training scenario in response to information identified with the diagnostic device to overcome the at least one performance deficiency and/or minimize further training of a learned training objective.

The system may further comprise a communication device 16 configured to provide the user and/or a training instructor information to facilitate overcoming the at least one performance deficiency. The communication device 16 may be a display device, or any other device that may be used to communicate information, such as but not limited to, an audible communication device and a tactile communication device.

Further details of regarding exemplary embodiments of the system 5 are disclosed in detail below. Though the details below discuss generally implementations in software (computer software code), and methods, those skilled in the art will readily recognize that the discussions are also applicable to the system. In general aspects, the system may include the measuring device 10 comprising a device to measure eye movement of the user, a device to measure electrical conductance of skin of the user, and/or a device to measure neural activity of a brain of the user wherein the device to measure neural activity further comprises a surface electrodes, a system of collected metrics of behavioral performance, and/or a heart rate monitor. The diagnostic device 12 may be further configured to determine whether a perceptual task has been performed incorrectly and/or correctly by the user, where the perceptual task may comprise a search task, a detection task, a recognition task, a procedural task, and/or a decision making task. The diagnostic device 12 is may be further configured to compare an expected eye tracking performance scan against a real-time eye tracking performance scan of the user to determine whether a deviation in performance exists. The diagnostic device 12 may be further configured to determine patterns associated with missed information by the user based on eye tracking performance of the user.

The diagnostic device 12 may be further configured to determine an emotional state of the user. The diagnostic device 12 may be further configured to identify an initiating factor of performance error for a given chain of events. The diagnostic device 12 may also be further configured to identify consistent patterns of performance issues within and across training scenarios, where performance issues may occur across time, stimuli, location and/or difficulty level. Additionally, the diagnostic device 12 may be further configured to at determine non-optimal cognitive states that may negatively impact a training scenario. The diagnostic device 12 may also be further configured to determine a level of expertise of the user based on a neurophysiological state, a physiological state, and/or behavioral state of the user compared to a neurophysiological state, a physiological state, and/or behavioral state associated with a profile of expertise, such as a novice level, a journeyman level, and/or an expert level.

The adaptation device 14 may be further configured to modify the training scenario to overcome the at least one performance deficiency of the user. The adaptation device 14 may be further configured to accelerate and/or compress the training scenario to minimize further training on the learned training objective. The learned training objective of the training scenario may comprise the system 5 being configured so that the user (or trainee) is put into a situation to experience a certain emotion during the training scenario.

FIG. 2 discloses a block diagram illustrating an exemplary embodiment of a method for adapting a training system based on information obtained from a user using a training system during a training scenario/session. The method 30 comprises measuring a neurophysiological state, a physiological state, and/or a behavioral state of a user while a training scenario is in progress, at 32. The method 30 further comprises diagnosing at least one performance deficiency of the user and/or a learned training objective while the training scenario is in progress, at 34. The method 30 also comprises adapting the training scenario during the training scenario and/or for a subsequent operation of the training scenario in response to information learned during diagnosing the at least one performance deficiency and/or a learned training objective to meet an objective of the training scenario, at 36. The method 30 further comprises communicating information to the user and/or a training instructor to facilitate overcoming the at least one performance deficiency, at 38.

Further details of regarding exemplary embodiments of the method 30 are disclosed below, but in general aspects include where measuring the neurophysiological state, physiological state, and/or behavioral state, at 32, further comprises measuring eye movement of the user, electrical conductance of skin of the user, and/or neural activity of a brain of the user. Measuring neural activity may comprise using surface electrodes, a system of collected metrics of behavioral performance, and/or a heart rate of the user.

Diagnosing at least one performance deficiency, at 34, may further comprise determining whether a perceptual task has been performed incorrectly and/or correctly by the user. The perceptual task may comprise a search task, a detection task, a recognition task, a procedural task, and/or a decision making task. Diagnosing at least one performance deficiency, at 34, may further comprise comparing an expected eye tracking performance scan against a real-time eye tracking performance scan of the user to determine whether a deviation in performance exists. Diagnosing at least one performance deficiency, at 34, may further comprise determining patterns associated with missed information by the user based on eye tracking performance.

Diagnosing at least one performance deficiency, at 34, may further comprise determining an emotional state of the user. Additionally, diagnosing at least one performance deficiency, at 34, also further comprise identifying an initiating factor of performance error for a given chain of events. Diagnosing at least one performance deficiency, at 34, may also further comprise identifying consistent patterns of performance issues within and across training scenarios, where performance issues may occur across time, stimuli, location and/or difficulty level. Additionally, diagnosing at least one performance deficiency, at 34, further comprises determining non-optimal cognitive states that may negatively impact a training scenario. Diagnosing at least one performance deficiency, at 34, could also further comprise determining a level of expertise of the user based on a neurophysiological state, a physiological state, and/or behavioral state of the user compared to a neurophysiological state, a physiological state, and/or behavioral state associated with a profile of expertise.

Additionally, adapting the training scenario, at 36, may further comprise adapting the training scenario to overcome the at least one performance deficiency of the user. Adapting the training scenario, at 36, may also further comprise accelerating and/or compressing the training scenario to minimize further training on the learned training objective. The learned training objective of the training scenario comprises experiencing a certain emotion during the training scenario.

The method 32 shown in the flowchart 20 may be performed with a computer software code having computer software modules where the computer software code is stored on a computer media and is executed with a processor. Thus, each process flow in the flowchart 20 is performed by a computer software module specific to the process contained in a specific process. For example, measuring a neurophysiological state and/or a physiological state of a user while a training scenario is in progress, at 32, is performed by a computer software module for comprises measuring a neurophysiological state and/or a physiological state of a user while a training scenario is in progress.

In explaining exemplary embodiments of the invention in more detail, measuring a state of a user comprises importing raw data from external equipment to obtain behavioral and physiological metrics that capture the user's, or trainee's, information processing, perceptual performance, including search, detection and recognition, procedural performance, cognitive state, and outcome performance. This data may be captured using eye tracking and Electroencephalography (EEG) raw data, and may be extended to include other physiological and neurophysiological tools in alternate embodiments. This raw data is captured with external hardware for the eye tracker and for an EEG headset. The eye tracking information may be handled by a virtual environment (“VE”) handler protocol which includes a bi-directional communication to correlate information between the eye tracker, a processor, and semantic data contained in a storage device. A computer running the training system will export collected data to provide raw data on timing and behavioral actions for diagnosis. EEG raw data is captured and initially processed with external hardware and software protocols before being stored.

The diagnostic component/device 12 collects the above listed measures on a computer that is either standalone or runs on the computer that is running the training program. Performance is analyzed near real time to pinpoint specific performance deficiencies based on root cause diagnosis, error/performance pattern diagnosis, expert trainee performance comparison, critical state and/or criterion performance identification and trainees' expertise levels.

Raw physiological data has limited utility in the training realm, and post-processing is required to interpret data to provide diagnosis of cognitive processing performance. Uniquely disclosed herein is a capability to capture and process physiological, neurophysiological, and/or behavioral data near real time to diagnose why an error occurred. Foundational to the exemplary embodiments disclosed herein is a definition of the root cause of an error, in addition to definitions of error patterns, individuals' learning curve, and perceptual expertise level.

Root Cause defines an initiating factor/error for a chain of events. The root cause can be at any point in the chain, from early information processing, to cognitive state (e.g. high workload, distraction), to procedural or manual missteps (e.g. pushing the wrong button). In order to diagnose the Root Cause, a performance assessment framework must be in place that is founded on a detailed listing of the subtasks that make up the chain of events that are related to outcomes of interest. For each of these subtasks, metrics of success/failure must be defined and instantiated. During the training exercise, monitoring and assessment of success/failure is conducted, and Root Cause is identified.

Additional diagnostics include comparison of learner performance against a standard or against an expert performance, known as Expert Comparison Diagnosis. These diagnoses allow deviations to be identified, to flag breakdowns or areas that need further improvement. Regardless of the Root Cause, a holistic view of overall performance can be examined, and learners can be assessed to determine if they have achieved standards.

Error patterns diagnosis refer to consistent performance issues across time, stimuli, location, difficulty, etc. Errors exhibit themselves in habitual performance problems that can be identified through diagnosis. Within the error patterns diagnostic method, error patterns can be identified which pinpoint the general nature of the failure (e.g. uses wrong scanning strategy for identifying threats), rather than the specific failure (e.g. failed to scan the target).

With respect to diagnosis of the user's or trainee's perceptual expertise level, the diagnoses of physiological and neurophysiological data are used to categorize trainees' level of expertise. Given performance data associated with different scenarios, perceptual performance profiles of novice, journeymen, and experts can be identified then compared to trainee performance to define trainees' level of expertise.

With respect to diagnosis of sufficient performance, in training environments, diagnostics may not only be needed to identify problem states, but also to identify opportunities in which trainees can be challenged because metrics indicate that a specific skill has been successfully acquired. Diagnosis may therefore have a goal of identifying opportunities for training acceleration or compression. This diagnosis can be accomplished by identifying performance criteria in behavioral or physiological data that indicate sufficiency.

Regarding Diagnosis of Critical States, certain information processing errors may put the benefit of the entire training session at risk. Behavioral or physiological metrics can be used to detect such critical states to drive adaptation of the training environment. Across the diagnosis methods listed above, resultant diagnostics will be used to interpret and present data and performance errors as trainees interact with the training system for a single session or across time. By itself, the outcome of the diagnostics provides data that can be used to provide feedback on the perceptual performance of individuals and teams; when used to tailor or adjust training to take into account patterns or breakdowns in performance, a unique, powerful training tool results.

The adaptation device 14, or controller, is provided. In an exemplary embodiment it is located within a software program storable on a media and operable within a processor. The adaptation device 14 may trigger one of 3 possible interventions, including driving an adaptation selection of customized training strategies designed to increase the learning of targeted skills through after-action feedback, application of skill-specific training strategies, during-action adaptations/adjustments, or scenario selection that tailors future events based on performance issues. This feedback is tailored both to specific errors and/or skills where trainee deficiencies were demonstrated. It is conducted either within the software program exemplifying an exemplary embodiment of the invention, instructions for adapting are provided to a human trainer, or directly communicated to a training program.

The utility of the described exemplary invention is wide-spread as it can be used to provide tailored training for perceptual skill sets, heretofore challenging and manual. An exemplary embodiment and several options for alternative embodiments are described below. Embodiments are categorized into Timing of Feedback/Strategy, Implementation for Perceptual processes, and additional skill sets. All embodiments can be described in terms of a trainee audience of individuals and/or teams.

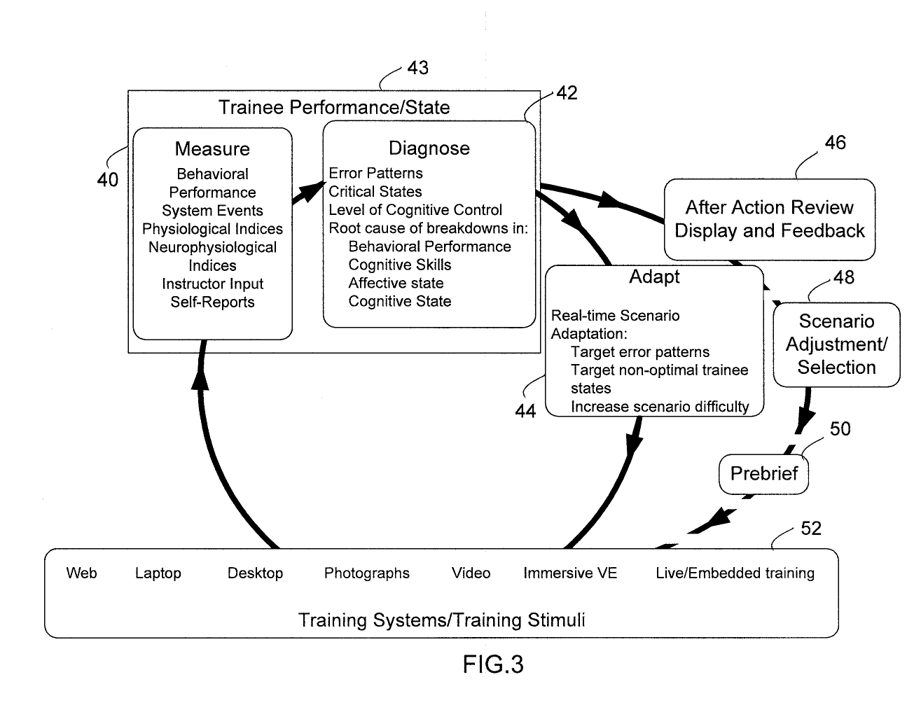

FIG. 3 discloses an exemplary embodiment of an adaptation of training via performance and diagnosis based on physiological, neurophysiological, and/or behavioral metrics. Input from data collection tools is received related to the measurement of perceptual processes and cognitive state. The raw data is analyzed in near real time using one of the diagnostic methods listed below. The diagnostic outcomes are presented in a display. An after action feedback/strategy is then selected and implemented. To accomplish this, the trainee would sit at a computer running a training program, with a trainer/instructor setting up and monitoring the training episode. The trainee would be outfitted with EEG hardware, and eye tracking hardware would be positioned to capture eye data. All raw data would be transmitted from the external hardware into an exemplary embodiment of the invention, such as the computer software code, where it is stored and processed. An adaptation mechanism selects and then triggers the appropriate feedback.

Diagnosis of breakdowns at the perceptual process level is targeted, and training remediation is focused on improving perceptual skills. Perceptual performance, situation assessment, decision making and situation awareness are key skill and knowledge sets for many complex operational environments. These skill sets focus on a human's capability to perceive a surrounding environment, gather information via key cues, abnormal conditions or targets in order to develop an understanding of current conditions, which is then fed forward to predicting future events, decision making and action.

Pattern recognition involves perceptual processes (e.g. scanning and detection) used in the identification of individual cues and groups of cues that may be indicative of an important event. This process describes an ability to detect individual cues, constellations of cues and configurations of cues that can be complex and temporally non-simultaneous. To gather key information, these cues must be discriminated amongst a myriad of other cues in order for idiosyncratic salience to be detected. Pattern recognition in complex environments may require an integration of a series of cognitive processes leading to the effective rendering of a decision.

With respect to the measure element 40, measurements consist of data collected from systems including an eye tracking device, an EEG device, EKG device, and/or a system of collected metrics from a training program computer in near real time. The metrics may comprise timed behavioral data and system events, ocular fixations on screen objects, the timing and duration of such fixations, EEG indices of workload, engagement, distraction, and drowsiness, and fixation- or event-locked changes in the EEG (fixation-locked event-related potentials (FLERPs)/event-related potentials (ERPs). For example, the eye tracker may stream gaze location ranging from 20 Hz to 40 Hz, wherein an exemplary embodiment of the invention determines fixations based on eye tracking algorithm (stays within 10 pixels for 100 ms). When a fixation is determined, it is sent to the training program. Specifically, within a VE Handler, a network communications technique, such as a TCP/IP protocol, is used to facilitate the training program requesting fixation location, a response that includes a current fixation (X, Y coordinate), the training program sending intersection of scenario object name, and the training program also send keystrokes, mouse clicks and streams user orientation/location information.

In another exemplary embodiment, the protocol used includes having an (application programming interface (API) used to communicate fixation information. Informing the training program of fixations (X, Y coordinate) also occurs. The training program sends intersection of scenario object name as well. To ones skilled in the art, it is apparent how heart rate monitors, galvanic skin response sensors or other physiological sensors could be used to collect alternative direct or indirect indicators of cognitive information processing. In yet another exemplary embodiment, physiological data could be used to measure cognitive states not related to information processing. For example, physiological data may be used to assess the emotional state of a trainee.

In the exemplary embodiment with respect to a Diagnose element 42, Root Cause, Expert Comparison, and Error Pattern diagnostic algorithms are instantiated to diagnose problems during perceptual information processing. The measure element 40 and the diagnose element 42 comprise a trainee performance/state element 43. Ones skilled in the can envision how alternative embodiments could be created in the same manner to target cognitive constructs beyond perceptual processing. Such embodiments could, for example, embrace problems with decision making, situation awareness or emotional state, and breakdowns in team performance issues.

Once the raw measures are captured with the external devices, they are stored and processed. The raw measures (or data) may be stored in a performance measurement log file that lists such information as, but not limited to, fixations—when found, fixation requests—from Training Program queries, fixation responses—Training Program sending back object information, mouse clicks, and/or keystrokes. This data is then processed. A semantic data file is loaded, the previously collected ata, or performance measurement data (listed above) is mapped to information in the semantic data file, and metrics are calculated based on internal algorithms. The data is then stored either solely in memory for immediate use or logged in a database for later use. Following this approach, diagnostic algorithms are run (as explained in further detail herein), and stored to a diagnosis database. An adaptation device, or computer software module, then selects and instantiates the feedback.

In an exemplary embodiment, root cause diagnosis is instantiated within the perceptual processing, that is, a determination of which of three perceptual subtasks, attention, detection, and perception/recognition, have been performed incorrectly in the case of a mission error. This is accomplished by assessing each subtask to pinpoint at which point the first error occurs. The subtasks are assessed using eye tracking data as follows. If a perceptual error such as a threat is not found, the firsts step is to first evaluate if the threat was visually attended, if not, lack of attention is the root cause. If so, the second step is to identify if a significant amount of attention was allocated to the threat to infer a level of detection. If not, then lack of detection is the root cause, if so then lack of recognition is the root cause. Amount of attention is deemed significant based on fixation durations which are defined based on the task at hand.

The root cause is calculated in one of two ways, either using eye tracking data with behavioral date or using eye tracking, EEG and behavioral data. In the former case, root cause can be attributed to attentional (scanning), detection or recognition errors. In this case, fixations and fixation durations are recorded and mapped to scenario objects. When a threat is not responded to or “missed” the diagnosis algorithm first determines if a fixation occurred on or near the target to determine if the target being missed was due to an attentional or scanning error, if the fixation did occur, then a determination is made as to whether this fixation duration exceeded a task specific threshold associated with a level of visual attention allocation which infers detection. If this threshold is not reached, a determination is the root cause is a detection error. If this threshold is exceeded and the target was indeed missed, recognition error is deemed to have occurred. In the latter case, root cause is attributable to either an attentional error, a cognitive processing error (detection-recognition) or a response error. In this case, when a response mistake is made, attentional errors are determines as specified above. In order to assess cognitive processing (detection/recognition), EEG signatures associated with fixations on the area of interest are compared to an EEG template and categorized as either interested (associated with detection/recognition) or non-interested (associated with lack of detection/recognition). If the target area is scanned and associated EEG signature is classified as non-interested, the the root cause is attributed to a detection/recognition error. If the signature is classified as interested and the response is incorrect, then the root cause is attributed to a response error.

Cognitive state diagnosis is made utilizing EEG raw data. This data is processed, then mapped to the eye tracking events to determine if deviations in states such as workload or distraction occur before errors in the perceptual process.

In an exemplary embodiment, expert comparison diagnosis is accomplished using eye-tracking performance to compare expert scan patterns against trainee scan patterns to contrast and analyze whether there are deviations in performance related to scanning strategies, looking at the correct cues, and efficient perceptual task performance. This is accomplished by analyzing eye tracking data in several ways including comparing which areas experts versus trainees allocated visual attention to, comparing which areas experts versus trainees allocated significant attention to (significant defined based on task), comparing the areas experts versus trainees spent the most time on, comparing the amount of attentional focus/attentional spread between experts novice (i.e., how many areas did they focus significant amount of attention), comparing systematic nature of expert versus trainee scan (i.e., was there a systematic pattern? Which was more systematic?), and comparison of visual attention allocation between high and low priority areas.

Specifically, in order to assess difference between where the expert and trainee looked, a determination is made as to the locations and associated objects the expert and trainee fixate upon, and a comparison of these two lists is performed to determine areas/objects scanned by one and not the other. In order to assess what objects experts versus trainees allocate a significant amount of attention to (visually interrogate), a determination of locations and associated objects on expert and trainee fixation durations exceed task specific thresholds associated with significant attention allocation. A compares is made with these two lists to identify differences. A determination is made regarding areas/objects for which the expert and trainee allocate most of their attention (areas they looked at the most). This may be done by using a control chart statistical method which will calculate a moving range and determine those locations which are above the upper limit or looked at significantly more. A determination of the number of objects/areas which received the most attention by the expert and trainee is made and a compare of these to determine who has more attentional focus versus spread is made. An allocation of attention between high and low priority areas by determining both number of fixations and fixation durations associated with high and low priority areas for expert and trainee is performed and determination of differences is made. A determination of differences in the systematic nature of the search of expert versus novice is made by calculating the number of times the scan changes direction and moves a significant length where a comparison between this result and an expert and trainee are made.

In the exemplary embodiment, error pattern diagnostics are accomplished by using database information on performance with objects in a training environment to drive analyses that determine if there are common threads in breakdowns across any objects or predefined patterns. This includes identifying which type of threat, location of threat, area within the display, distance of threat from observer, and characteristics of threat which lead to most targets going unattended, undetected or unrecognized. Target characteristics in the include orientation of threat, level of occlusion of threat, level of camouflage/contrast of threat, texture of threat, static/dynamic nature of threat, shape of threat, light/reflective nature of threat and/or color of threat. It also includes distracter items most mistaken for threats. It also includes common threads in attention/scanning areas such as types of objects and locations, high and low priority areas and negative and positive space. Also included are environmental conditions which lead to most errors including type of terrain, time of day, and visibility conditions, as well as performance conditions such as lack of tool use, or time and accuracy issues. Any combination of the above variables can be used to identify patterns as well.

Error pattern diagnosis is accomplished using eye tracking data to determine patterns associated with target misses to identify underlying performance issues. By doing so, a determination of patterns related to both target and environment characteristics is performed. To facilitate identification of error patterns associated with detecting targets, each target is tagged with information related to the full range of characteristics mentioned above. After performance of several scenarios with a range of targets embedded, an analysis of the targets missed is performed, and a determination of which of the target parameters or levels within the parameters are associated with most target misses is accomplished. To facilitate identification of error patterns associate with search/scan strategies, all locations within the scenario are tagged with information related to type and nature of location as discussed above. After each scenario is scanned, an analysis of those areas which were not scanned is performed and identification of the parameters or levels within the parameters associated with locations not scanned is performed. To facilitate identification of errors patterns associated with general environmental performance, each scenario is tagged with information related to environmental conditions and difficulty levels and after multiple scenario performance, an identification of scenarios in which there was mission failures or significant errors is performed, and identification of environmental/scenario characteristics associated with mission failures is performed.

In an exemplary embodiment, diagnosis may have a goal of identifying opportunities for training acceleration or compression. For example, an evaluation of ocular scan patterns in a monitoring task could indicate near-optimal performance, suggesting that the associated skill has been acquired and requires no further training.

Critical states are diagnosed to drive adaptation of the training environment. Certain information processing errors may put the benefit of the entire training session at risk. In an exemplary embodiment, the training goal may be to practice procedures following the detection of an Improvised Explosive Device (IED) in a combat convoy simulation. Passing the IED due to unsuccessful detection would jeopardize the goal of the training session because the routines following the detection would not be instantiated. In another embodiment, a Forward Air Controller may be required to detect an incoming aircraft in order to perform terminal control towards the target. A critical state in information processing occurs if the aircraft is detected too late so that not enough time is left to complete all required tasks before the aircraft over flies the target. In one embodiment, this critical state could be detected by evaluating whether and when ocular fixations occurred on the aircraft. Additionally, cognitive readiness indicators, such as (in)attention or (dis)engagement could be evaluated to assess readiness for learning material.

Though the above example likely is based on a virtual environment training program/session/scenario, those skilled in the art will readily recognize that it, and exemplary embodiments of the invention are also applicable to two-dimensional training program, such as static screens as are developed and viewed in a Microsoft® PowerPoint® training program/session/scenario. Therefore, it should be evident the type of training program/session/scenario is not limited. For example, as further illustrated in FIG. 3, the training program/training system/training stimuli 52 may be associated with a laptop, desktop, photographs, video, immersive VE, and Live/Embedded training.

The Adaptation component or element 44 changes the training program directly, or creates instructor or trainee interfaces that display the diagnosed errors and/or the next course of action for trainees. Feedback and strategy implementation occurs after the training event, including instructor displays of diagnosis outputs, feedback to trainees, or training lessons that focus on the implementation of strategies that facilitate learning opportunities to address errors that have occurred. This adaptation controller (or device) selects an appropriate type of feedback (as direct trainee feedback, trainer interfaces to illustrate trainee problem areas, or to the Training program to select training (e.g. scenarios) that focuses on trainee problems.

Specifically, each type of error that is diagnosed is linked to a mitigation matrix database. The database stores specifics on the error and creates displays for instructors, creates feedback displays for trainees, and selects remediation lessons for trainees. Based on the root cause diagnosed, the mitigation matrix will prescribe and automatically drive feedback designed to address that specific subtask error. In the preferred embodiment, feedback mechanisms are instantiated real time. In another exemplary embodiment, post training, expert scan paths are used to improve visual search by showing trainees how an expert viewed the same training scene and how the trainee's performance was different.

Expert scan paths have proven successful in improving visual search, by showing trainees precisely how an expert viewed the same training scene. Both expert scan paths for the training program's environmental scenario may be presented to the trainee, along with the trainee's own scan path. Specifically, elements of the trainee scan path are included to highlight differences between expert and trainee, providing trainees with information not only on where they should have looked, but also where they did look to guide them in areas in need of improvement. In addition to the presentation of the scan path, elaborative feedback is provided to further illustrate critical cues and pattern of search. Auditory elaborative feedback will aid in abstraction of a specific scan pattern to higher level strategies of where they should look in novel situations. This feedback addresses both perceptual and conceptual aspects of “where to look.”

When breakdowns in detection performance are found, a Detection Feedback module is presented, such as may be part of element 46, or an independent element. The detection feedback strategy combines massed practice with elements of variation on dimensions relevant to detection (e.g., for a military threat detection task: orientation and occlusion) to form a training strategy for anomalous cue detection. Also included in the training strategy is a task which ensures an adequate level of processing (e.g. detection or discrimination task which requires visual interrogation). This strategy is instantiated by the creation of a Feedback module that presents trainees with a series of screens in which targets (e.g., rifles) are presented at varying orientations and levels of occlusion. To ensure visual interrogation during the modules, trainees are required to discriminate if targets differ (perceptual discrimination task) and/or on which of these two dimensions two targets differ (conceptual discrimination task). Through multiple presentations of targets and the array of variations, it is hypothesized that trainees will become both biologically sensitized to stimulus and stimulus features as well as perceptually sensitized by facilitating the development of global strategies for extracting critical cues in threat detection.

A recognition feedback strategy consists of attribute isolation methods that highlight central attributes of target concepts to improve general understanding of phenomenon. Feedback aimed at correcting recognition errors physically highlights key visual components and provides information that elaborates on the conceptual background knowledge associated with the physical cue (e.g., shimmer of light in a window may indicate the reflection off a sniper scope). This marries the perceptual knowledge with the conceptual knowledge necessary to recognize critical cues in the environment, improving trainees' ability to recognize threats in both similar and novel situations.

Additionally, based on error patterns identified, feedback modules which address error patterns related to trainee previous performance will be automatically developed and displayed. These will include presentation of past content associated with errors and a highlighting of characteristics/levels of parameters related to the error pattern.

The After-Action Review (AAR) 46 further has displays that will be populated with mission outcome performance as well as diagnostic information resulting from the diagnosis methods. This will include root causes, error patterns, trainee scan data, cognitive state data as measured by EEG, mission timelines surrounding errors with physiological and neurophysiological data tied to the time preceding and following an error. Also illustrated is a scenario adjustment/selection element 48, and a prebrief element 50.

In another exemplary embodiment, feedback occurs during the training event, including real time scenario adjustment, such as with the scenario adjustment selection element 48, that focus on the real-time implementation of strategies that allow learning to address errors that have occurred via changing the training program. The same diagnostic methods discussed above are used, but outcomes of diagnostics are fed into an adaptation management component that can dynamically select, configure and apply adaptations to the training program, based on the diagnostic outcome.

Example changes to the training program could include adjusting the difficulty of the training program's scenario (e.g. making it easier via ‘decluttering’ extraneous visual cues, making it more difficult by adding more targets).

In another exemplary embodiment, a process includes receiving performance data recorded by the targeted training system and analyzing that data in combination with inputs received from data collection tools related to the measurement of user emotional state, to trigger scenario modifications in real-time. This could be accomplished with the prebrief element 50. The script-based scenario modifications will be triggered with a goal of modifying the emotional state of the trainee to a target emotional state. Metrics will consist of real time system collected performance metrics such as time to perform tasks, errors made, and accuracy of task performance as well as assessments of emotional states developed from measures such as voice classifications, facial features, and physiological measures including EEG, and galvanic skin response (GSR).

In another exemplary embodiment, an exemplary embodiment of the invention is driven by a matrix that maps real-time scenario modification techniques aimed at driving trainees to targeted emotional states to the emotional state/performance combinations for which they are applicable. By categorizing emotions into higher level training constructs that they represent and evaluating the occurrence of them based on high and low performance, methods/techniques/approaches are developed to guide trainees to the targeted emotional state.

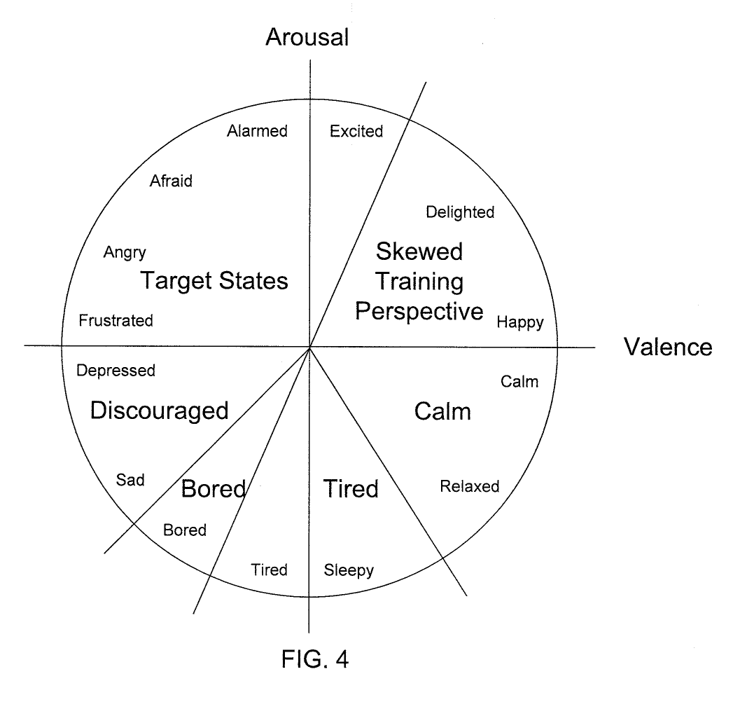

For example, FIG. 4 presents a classification of emotions applicable to a variety of military training exercises where the target state includes emotions such as fear, anger, frustration, and excitement. Following the example presented in FIG. 3 above, induction techniques are developed to drive trainees to the target emotion based on specific goals of the techniques (see Table 1 for a subset of goals). Guidance is then provided to system developers to integrate specific induction techniques into the training system to allow for system adaptation in real-time or scenario selection based on the integrated techniques.

TABLE 1
Emotional State/Performance EIT goals

| Emotional Category | High Performance | Low Performance |
|---|---|---|
| Target State | No change required | Provide guidance |
| | | Remove scenario stressors |
| Skewed Training | Add stressors | Add stressors that don't affect |
| Perspective | that increase | task difficulty (i.e. dramatic |
| | task difficulty | musical scores) |
| | (i.e. more enemies) | Stress importance of training |
| Discouraged | Provide | Provide guidance |
| | encouragement/ | Remove scenario stressors |
| | praise of high | |
| | performance | |

To allow for flexibility across training environments instructors may be guided through the process of integrating induction techniques at three different levels, specifically between scenario modifications, within-scenario context dependent scenario real time adaptations, and context independent real time adaptations. As can be seen in Table 1, the level of responsiveness of system adaptations is dependent on how the induction techniques are integrated.

TABLE 2
Emotion Induction Technique Types

| | | | Responsiveness of |
|---|---|---|---|
| Integration Level | Description | Example | training modification |
| Between scenario | Emotion induction techniques | Lighting levels are | Scenario selection |
| | are developed into a | adjusted by changing | guidance can be |
| | separate scenario that can | the time of day within | provided after |
| | be loaded after current | the scenario file, | scenario completion |
| | scenario is completed. | creating separate night | |
| | | and day scenarios. | |
| Within scenario context | Emotion induction techniques | Additional opposing | Scenarios can be |
| dependent | are designed to be activated | forces can be activated | made to future |
| | and deactivated within the | although the method | sectors of the |
| | scenario but are activated | that is used to do varies | training |
| | differently based on the | based on the portion of | environment |
| | sector of the scenario that | the scenario that they | |
| | the trainee is in. | are in. | |
| Within scenario context | Emotion induction techniques | Suspenseful music is | Techniques can be |
| independent | are designed to be activated | played using the same | applied at any time |
| | at any time during a scenario, | script no matter where | in a scenario. |
| | regardless of context | in a scenario the | |
| | | trainee is. | |

After developing the emotion induction technique matrix and gathering information on how each technique is integrated into the current training, a scenario selection guidance and/or modify scenarios may be provided in real time based on the combination of trainee performance and emotional state.

While the invention has been described with reference to various exemplary embodiments, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated, any use of the terms first, second, etc., do not denote any order or importance, but rather the terms first, second, etc., are used to distinguish one element from another.

1. A method for adapting a training system based on information obtained from a user using a training system during a training scenario, the method comprising:
measuring a neurophysiological state, a physiological state, and/or a behavioral state of a user while a training scenario is in progress;
diagnosing at least one performance deficiency of the user and/or a learned training objective while the training scenario is in progress; and
adapting the training scenario during the training scenario and/or for a subsequent operation of the training scenario in response to information learned during diagnosing the at least one performance deficiency and/or a learned training objective to meet an objective of the training scenario.

2. The method according to claim 1, wherein measuring the neurophysiological state, physiological state, and/or behavioral state further comprises measuring eye movement of the user, electrical conductance of skin of the user, and/or neural activity of a brain of the user wherein measuring neural activity comprises using surface electrodes, a system of collected metrics of behavioral performance, and/or a heart rate of the user.

3. The method according to claim 1, wherein diagnosing at least one performance deficiency, further comprises determining whether a perceptual task comprising a search task, a detection task, a recognition task, a procedural task, and/or a decision making task, has been performed incorrectly and/or correctly by the user.

4. The method according to claim 1, wherein diagnosing at least one performance deficiency further comprises comparing an expected eye tracking performance scan against a real-time eye tracking performance scan of the user to determine whether a deviation in performance exists.

5. The method according to claim 1, wherein diagnosing at least one performance deficiency further comprises determining patterns associated with missed information by the user based on eye tracking performance.

6. The method according to claim 1, wherein diagnosing at least one performance deficiency further comprises determining an emotional state of the user.

7. The method according to claim 1, wherein diagnosing at least one performance deficiency further comprises identifying an initiating factor of performance error for a given chain of events.

8. The method according to claim 1, wherein diagnosing at least one performance deficiency further comprises identifying consistent patterns of performance issues within and across training scenarios, where performance issues may occur across time, stimuli, location and/or difficulty level.

9. The method according to claim 1, wherein diagnosing at least one performance deficiency further comprises determining non-optimal cognitive states that may negatively impact a training scenario.

10. The method according to claim 1, wherein diagnosing at least one performance deficiency further comprises determining a level of expertise of the user based on a neurophysiological state, a physiological state, and/or behavioral state of the user compared to a neurophysiological state, a physiological state, and/or behavioral state associated with a profile of expertise.

11. The method according to claim 1, wherein adapting the training scenario further comprises adapting the training scenario to overcome the at least one performance deficiency of the user.

12. The method according to claim 1, wherein adapting the training scenario further comprises accelerating and/or compressing the training scenario to minimize further training on the learned training objective.

13. The method according to claim 1, further comprises communicating information to the user and/or a training instructor to facilitate overcoming the at least one performance deficiency.

14. A computer software code stored on a computer readable media and executable with a processor for adapting a training system based on information obtained from a user using the training system during a training scenario, the computer software code comprising:
a computer software module for measuring a neurophysiological state, a physiological state, and/or a behavioral state of a user while a training scenario is in progress, when executed with a processor;
a computer software module for diagnosing at least one performance deficiency of the user and/or a learned training objective while the training scenario is in progress, when executed with the processor; and
a computer software module for adapting the training scenario during the training scenario and/or for a subsequent running of the training scenario in response to information learned during diagnosing the at least one performance deficiency and/or a learned training objective to meet an objective of the training scenario, when executed with the processor.

15. The computer software code according to claim 14, wherein the computer software module for measuring the neurophysiological state, physiological state, and/or behavioral state further comprises a computer software module for evaluating measured eye movement of the user, electrical conductance of skin of the user, and/or neural activity of a brain of the user wherein the computer software module for measuring neural activity comprises processing information from surface electrodes, a system of collected metrics of behavioral performance, and/or a heart rate of the user.

16. The computer software code according to claim 14, wherein the computer software module for diagnosing at least one performance deficiency further comprises a computer software module for determining whether a perceptual task comprising a search task, a detection task, a recognition task, a procedural task, and/or a decision making task, has been performed incorrectly and/or correctly by the user, when executed with the processor.

17. The computer software code according to claim 14, wherein the computer software module for diagnosing at least one performance deficiency further comprises a computer software module for comparing an expected eye tracking performance scan against a real-time eye tracking performance scan of the user to determine whether a deviation in performance exists, when executed with the processor.

18. The computer software code according to claim 14, wherein the computer software module for diagnosing at least one performance deficiency further comprises a computer software module for determining patterns associated with missed information by the user based on eye tracking performance, when executed with the processor.

19. The computer software code according to claim 14, wherein the computer software module for diagnosing at least one performance deficiency further comprises a computer software module for determining an emotional state of the user, when executed with the processor.

20. The computer software code according to claim 14, wherein the computer software module for diagnosing at least one performance deficiency further comprises a computer software module for identifying an initiating factor of performance error for a given chain of events, when executed with the processor.

21. The computer software code according to claim 14, wherein the computer software module for diagnosing at least one performance deficiency further comprises a computer software module for identifying consistent patterns of performance issues within and across training scenarios, where performance issues may occur across time, stimuli, location and/or difficulty level, when executed with the processor.

22. The computer software code according to claim 14, wherein the computer software module for diagnosing at least one performance deficiency further comprises a computer software module for determining non-optimal cognitive states that may negatively impact a training scenario, when executed with the processor.

23. The computer software code according to claim 14, wherein the computer software module for diagnosing at least one performance deficiency further comprises a computer software module for determining a level of expertise of the user based on a neurophysiological state, a physiological state, and/or behavioral state of the user compared to a neurophysiological state, a physiological state, and/or behavioral state associated with a profile of expertise.

24. The computer software code according to claim 14, wherein the computer software module for adapting the training scenario further comprises a computer software module for adapting the training scenario to overcome the at least one performance deficiency of the user, when executed with the processor.

25. The computer software code according to claim 14, wherein the computer software module for adapting the training scenario further comprises a computer software module for accelerating and/or compressing the training scenario to minimize further training on the learned training objective, when executed with the processor.

26. The computer software code according to claim 14, further comprises a computer software module for communicating information to the user and/or a training instructor to facilitate overcoming the at least one performance deficiency, when executed with the processor.

27. A system for adapting a training system based on information obtained from a user using the training system during a training scenario, the system comprising:
a measuring device configured to measure a neurophysiological state, a physiological state, and/or a behavioral state of a user while a training scenario is in progress;
a diagnostic device configured to identify at least one performance deficiency of the user and/or a learned training objective gathered from the neurophysiological state, physiological state, and/or behavioral state measured while the training scenario is in progress; and
an adaptation device configured to modify the training scenario during the training scenario and/or for a subsequent running of the training scenario in response to information identified with the diagnostic device to overcome the at least one performance deficiency and/or minimize further training of a learned training objective.

28. The system according to claim 27, wherein the measuring device comprises a device to measure eye movement of the user, a device to measure electrical conductance of skin of the user, and/or a device to measure neural activity of a brain of the user wherein the device to measure neural activity further comprises surface electrodes, a system of collected metrics of behavioral performance, and/or heart rate monitor.

29. The system according to claim 27, wherein the diagnostic device is further configured to determine whether a perceptual task, comprising a search task, a detection task, a recognition task, a procedural task, and/or a decision making task, has been performed incorrectly and/or correctly by the user.

30. The system according to claim 27, wherein the diagnostic device is further configured to compare an expected eye tracking performance scan against a real-time eye tracking performance scan of the user to determine whether a deviation in performance exists.

31. The system according to claim 27, wherein the diagnostic device is further configured to determine patterns associated with missed information by the user based on eye tracking performance of the user.

32. The system according to claim 27, wherein the diagnostic device is further configured to determine an emotional state of the user.

33. The system according to claim 27, wherein the diagnostic device is further configured to identify an initiating factor of performance error for a given chain of events.

34. The system according to claim 27, wherein the diagnostic device is further configured to identify consistent patterns of performance issues within and across training scenarios, where performance issues may occur across time, stimuli, location and/or difficulty level.

35. The system according to claim 27, wherein the diagnostic device is further configured to at determine non-optimal cognitive states that may negatively impact a training scenario.

36. The system according to claim 27, wherein the diagnostic device is further configured to at determine a level of expertise of the user based on a neurophysiological state, a physiological state, and/or behavioral state of the user compared to a neurophysiological state, a physiological state, and/or behavioral state associated with a profile of expertise.

37. The system according to claim 27, wherein the adaptation device is further configured to modify the training scenario to overcome the at least one performance deficiency of the user.

38. The system according to claim 27, wherein the adaptation device is further configured to accelerate and/or compress the training scenario to minimize further training on the learned training objective.

39. The system according to claim 27, further comprising a communication device configured to provide the user and/or a training instructor information to facilitate overcoming the at least one performance deficiency.

40. The system according to claim 39, wherein the communication device is a display device.
